(19) United States
(12) Patent Application Publication
(10) Pub. No.: US 2018/0199548 A1
(43) Pub. Date: Jul. 19, 2018

(54) Break Away Animal Collar

(71) Applicant: Jeffery R. Jones, San Diego, CA (US)

(72) Inventor: Jeffery R. Jones, San Diego, CA (US)

(21) Appl. No.: 15/874,836

(22) Filed: Jan. 18, 2018

Related U.S. Application Data
(60) Provisional application No. 62/447,743, filed on Jan. 18, 2017.

(51) Int. Cl. A01K 27/00; A44B 11/25

(52) U.S. Cl. CPC A01K 27/005; A44B 11/2592; A01K 27/001

(57) ABSTRACT

A break away collar formed by a strap having both ends in a coupling. The coupling is between a projection on one end of the strap and a recess such as an opening or a recessed surface engaged at the other end. Force applied to the strap when in the collar configuration such as by an animal hanging from an object while restrained by the collar will cause a curved surface of the projection to disengage the coupling and release the strap from the coupling.

This application claims priority to U.S. Provisional patent application Ser. No. 62/447,743, filed on Jan. 18, 2017, which is incorporated herein in its entirety by this reference thereto.

### FIELD OF THE INVENTION

This invention relates in general to animal collars such as those worn by cats. More particularly, it relates to such collars configured with a coupling means or cooperative fastener engaged between the two ends of the collar, which breaks-away or decouples when a force of predetermined or greater level is applied by the animal or external object to the collar, thereby removing the threat of the cat becoming trapped with a structure of object by the collar being caught thereon.

### BACKGROUND OF THE INVENTION

Some animals, such as dogs, are required by law to wear a collar outdoors with tags listing contact and immunization records. Other pets such as cats, wear collars for purposes of identification and on occasion insect repelling. Although some owners only allow their animals to roam indoors within fenced areas, many animals such as cats, conventionally are not easily restrained and are allowed to roam.

Animals such as dogs and in particular cats due to their low weight, when wearing conventional neck collars risk injury or death from ensnarement on fixed protrusions such as tree branches or fence posts, other objects. Such ensnarement exposes the animal to potential harm from predators in some environments, injury from exposure, and potential strangulation. Consequently, some owners have sought to minimize harm from ensnarement by providing releasable collars or collars which break away under force which may be generated by the pet who becomes ensnared.

As such, a variety of auto-disengaging collars have been developed which are configured with fasteners or construction adapted to decouple from the animal when a threshold tangential is applied which is indicative of the animal being ensnared or caught upon something by the collar.

A number of conventional devices available which are similar to others in the current art are taught in U.S. Pat. No. 4,881,492 (Jones). The teachings of Jones, however, disclose a fastener for the collar which is prone to jamming and failure to disengage should dirt become lodged with the employed combination of snaps or trigger plugs in a direction parallel to the tangential collar strain. Other collars, conventionally sold, have no accommodation included for animals who become ensnared and generate force which is communicated to the collar to try and free themselves. However, such a collar should also have an engagement of the ends to the band forming it, which will remain firmly engaged at other times to maintain it on the cat, dog, or other animal for its intended purposed.

The disclosed device herein provides for a break away pet collar with a fastener engaging the two ends of the band or strap forming the collar, configured to consistently and reliably decouple under a determined potentially dangerous applied force. The coupler on the collar device herein is configured not to disengage easily below a determined force correlating to ensnarement, to thereby maintain the collar on the neck of the animal when they are not in trouble. The coupler on the collar herein employs mating fasteners which connect to engage the fastener, and which are configured to be easily engaged and disengaged by the user.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of this invention to provide an animal collar having a break-away coupling to engage it when worn by pet animals such as for example cats, to prevent injury from entanglement or strangulation.

It is a further object of this invention to provide a collar with such a breakaway coupling which concurrently forms a linear arc consistent with the general curvature of the collar.

It is a further object of this invention to provide a collar with a disengaging coupler having a coupling member which translates perpendicularly to the tangential collar strain communicated to it, and is thus immune to jamming from lodged dirt.

These and other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the present invention, as embodied and broadly described herein, the present invention provides a device configured to form an anti-choking animal collar. The disclosed device is especially well adapted for employment on cats, but can be worn by dogs and other pets also. The formed collar device is primarily composed of a strap sized to encircle the neck of the intended animal, having a break away coupling formed of two cooperatively engaging half fasteners, and a snap and hook.

The first portion of the cooperative fastener engageable to form the break away coupling is permanently affixed to the proximal end of the strap through the affixing of one or more of the cooperative fastener halves, upon the first portion and the strap. The second portion of the break away coupling uses a fastener configured for removable engagement with the first portion to form a connection of the coupling allowing for temporary engagement of one end of the strap with the distal end of the strap. This coupling forms the strap to a removable band or loop adapted for securement around the neck of an animal such as a cat.

The first and second portions of the complimentary fastener halves forming the coupling, adapted to disengage under force, can be engaged to their respective position on the collar using one or a combination of affixing means from a group including rivets, nuts, bolts, adhesive, epoxy, ties, straps or loops.

Although other means for affixing the complimentary halves of the fastener forming a buckle may also be employed. The strap or belt defining the body of the collar, in a currently preferred mode of the device herein, has connectors thereon configured to complimentarily engage with the break away coupling forming a buckle. In one mode, the connectors include one or a plurality of permanently positioned projections sequentially positioned on the first end of the strap. The projections are configured to be complimentary to and engage with a recess in the buckle and thereby form a break away coupling of both ends of the collar which disconnects under a predetermined force. In another mode of the device, a plurality of sequentially positioned recesses are sequentially positioned at the first end of the strap, which are complimentary to and removably engage with a mating projection on the buckle.

The sequential plurality positioning of the projections is preferred because this configuration enables the collar of the device to accommodate a specific range of animal neck sizes by sequential engagement of the spaced projections or recesses which engage with the buckle to form the break away coupling. This configures a collar adjustable in diameter which is removable under force exerted by the animal wearing it if need be. A pin feature extending outwards from the proximal end of both sides of the buckle member which is positioned to cover either a projection or recess as the case may be, mates with a matching hole in a flexible sidewall of the buckle to create a permanent but freely rotating hinge fixture. Additionally, two projections which extend outwards from the distal end of both sides of the snap or buckle member are positioned to temporarily mate with matching, aligned holes in the sidewall of the buckle.

Consequently, upon compressing the buckle member or snap toward the buckle, the snap projections will engage within the side walls of the buckle and engage with their corresponding holes in the buckle, to temporarily arrest the rotation of the snap or buckle member per the closed configuration of the device.

Per one preferred mode of the device, engagement is accomplished by inserting the distal end of the strap into the second end of the buckle, with the buckle in an opened configuration, with only one projection positioned below a recess in the buckle member, and engaging the closed configuration of the device as described above. This constrains the projection between the cavity formed between the buckle and the recess in the buckle member. Constraining the distal end of the strap, as such, creates a flexible semi-rigid loop that can temporarily engage around the neck of an animal.

In an alternative mode of the device, one of a plurality of recesses formed into the distal end of the strap, can engage with a mating projection extending from the lower end of the buckle member. When the buckle member is moved to the closed configuration, the projection operatively engages within the recess connected to the distal end of the strap.

The geometries of the recess on the buckle member which is formed as a chamfered or ramped face of the inner cavity of the buckle member, when employed with protrusions on the strap, or with a projection when employed with recesses in the strap, should be designed to accommodate a specific range of force generated by animal weight or the force of the animal trying to escape. In this fashion, when such forces communicated to the collar device engaged around the neck of the animal, a break away of the coupling between a projection and recess holding the ends of the strap occurs, which disengages the buckle member from the strap.

In the configuration herein, an applied tensile force between the distal and proximal ends of the strap, pulling the distal end of the strap away from the proximal end, will impart force to cause the curved projection to engage with a recess, to impart force to the curved surface similar to a ramp, to disengage it. In the case of projections on the strap, the projection slides laterally from the force along the internal ramp formed by a chamfered or recessed face of the buckle member. This force and the ramped engagement causes a lifting of the buckle member to disengage the protrusion and the distal end of the strap.

In modes where the protrusion extends from the bottom of the buckle member and engages a recess in the strap, the curved wall of the protrusion communicates an upward force along the ramp formed by the curved wall, to open the connection when side edges of a recess in the strap are forced against the curved edge. The result being that the upward force generated by the lateral force of the recess against the curved projection, opens the buckle member to release the collar.

Because the collar may be used with a leash, a hook may be provided engaged with the strap. Such can be configured to allow for attachment of leashes and identification tags to the animal. The hook can removably or permanently engage with the strap or with the buckle.

In one preferred mode of the device, the distal end of the strap terminates at, and does not extend beyond the second portion of the buckle when engaged, such that only one projection or recess is captured by the complimentary fastener on the bottom surface of the buckle member engaging the ends to form the collar. Consequentially, for the device in this preferred mode, to maintain a snug fit against the particular size of the neck of an animal, the strap may have to be cut and shortened to reduce the diameter of closed configuration of the device.

For secure and continuous device utilization and adjustment as the animal grows, another preferred mode of the device eliminates the necessity for strap trimming. This is accomplished by providing an aperture allowing the distal end of the strap to pass through the buckle and underneath the proximal end of the strap. Employing the device per this preferred mode herein, the strap is drawn snugly around the neck of the animal and communicated through the buckle so that only one projection lies below the buckle member.

Formation of the closed configurations of the first and second preferred modes of the device, through compressing the buckle member and buckle, are thereafter identical. Animals with larger neck diameters can potentially impart greater force upon the device during hazardous entanglement or safe, allowable motion and play. As such, in another preferred mode of the device, the axial height of the distinct projections increases, to impart a greater mechanical advantage against the clip, per their sequential position from the distal end of strap. As a consequence, larger animals employing this preferred mode of the device herein are less prone to false-positive snap disengagement and potential device loss during non-hazardous play and movement, while smaller animals can avoid disengagement failure under duress.

In all preferred modes of the device, the strap can be composed of one or a combination of pet-friendly materials including but not limited to: leather, plastic, fabric, carbon fiber or metal. Additionally, the buckle, snap, projections, and hook can be made from one or a combination of durable, water resistant materials including but not limited to: metal, plastic, carbon fiber or wood.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other animal collar devices for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion.

In the drawings:

FIG. 1 depicts a top view of the collar device in its flat or planar configuration showing the break away coupling disengaged and separated first and second ends of the strap.

FIG. 2 displays a perspective front view of a first preferred mode of the device of FIG. 1 depicting two cooperating fasteners forming a coupling to hold the strap or band of the body in a circular form.

FIG. 3 shows a cross sectioned view of a removably engageable buckle of the collar device with a coupling engaging both the first and second fastener portions positioning the buckle in operative engagement.

FIG. 4 depicts an enlarged front view of the operative engagement of a coupling between two ends of the strap forming the collar showing a projection on the strap engaging into an aperture.

FIG. 5 shows an enlarged view of another mode of operative engagement of the coupling between two ends of the collar wherein one end of the collar communicates through the buckle allowing sizing of the collar.

FIG. 6 depicts a mode of the device where the recesses are formed sequentially in the strap, and are configured to engage a curved projection extending from the buckle member, and also shows the axis A1 of the strap at one end aligned with the axis A2 of the strap at an opposite end.

FIG. 7 shows a mode of the device with sequentially positioned projections at the distal end of the strap, which engage a ramped recess which is positioned in a flexible rather than hinged member of the other modes of the device, and also shows a misalignment between the axis A1 of the strap at one end of the strap with the axis A2 of the strap at an opposite end.

FIG. 8 depicts a mode of the device as in FIG. 7, but with sequential recesses formed in the distal end of the strap adapted to engaged a projection extending from the flexible buckle member as in FIG. 7.

### DETAILED DESCRIPTION OF THE INVENTION

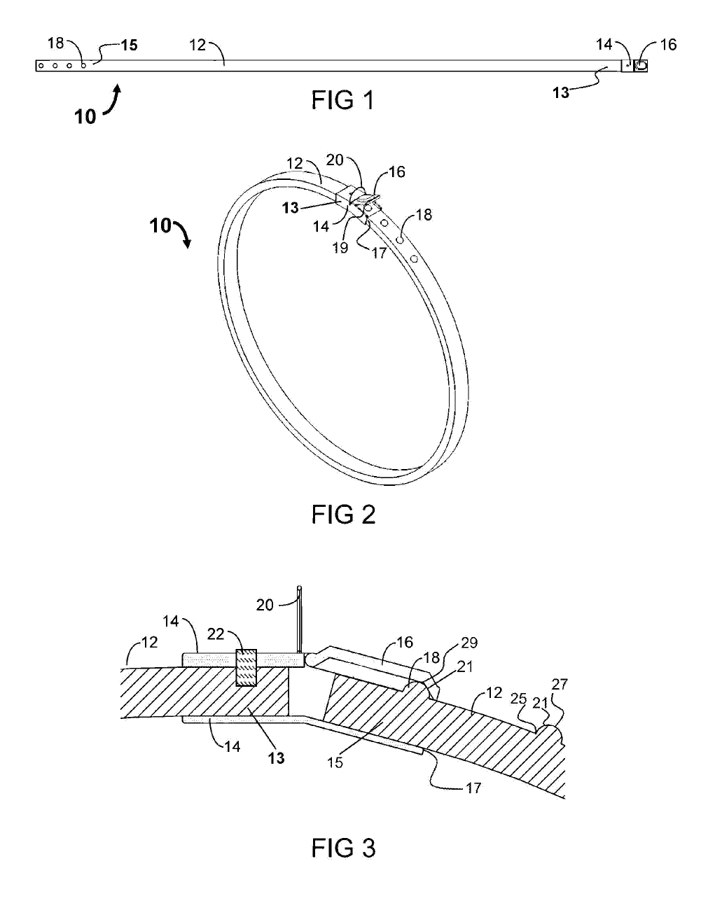

Now referring to drawings in FIGS. 1-8, wherein similar components are identified by like reference numerals, there is seen the device 10 configured as a break away collar to prevent choking and injury to the animal wearing it.

As shown in FIGS. 1-8, the device 10 in all preferred modes includes a band or strap 12, configured with a break away coupling engaging the two ends of the strap 12 to form a collar configuration of FIG. 2. In modes of the device 10 where it is to be hooked to a leash or lanyard, a snap 20 or connector adapted to engage the distal end of a leash may be provided. In all modes of the device 10 having a buckle 14, the buckle 14 is permanently affixed in an engagement to a first end 13 or distal end 15 of the strap 12. Such engagement may be with one or more fasteners 22 (FIG. 3), or other means of engagement such as adhesive or crimping.

At an open end 17 of the buckle 14 in all modes of the device 10 herein, is formed a break away coupling providing a removable engagement or coupling of the first end 13 of the strap 12 to the distal end 15 of the strap 12. When in said coupling the strap 12 forms to a circular loop or collar configuration shown in FIG. 2, adapted for encirclement of the neck of the animal, such as a cat. The fastener 22 engaging the buckle 14 to the first end 13 of the strap 12, can include one or a combination of such fasteners from a group including rivets, nuts, bolts, epoxy, ties, straps, sewing, adhesive, loops or other means for fixed engagement as would occur to those skilled in the art.

On the distal end 15 of the strap 12, opposite the first end 13 engaged with the buckle 14, depending on whether a projection 18 or recess or opening are located on the buckle member 16, are positioned a sequential array of one or more permanently engaged projections 18, or as shown in FIGS. 6 and 8, a plurality of sequentially positioned recesses shown as openings 19. By sequentially positioned is meant each is in a line and spaced from each other in a sequence extending away from the end of the strap.

In all modes of the device 10 herein, the coupling which is disengaged at a determined force on the strap 12, is formed by projections 18 having a curved surface 21 which engage within a recess formed as shown in FIGS. 6-8 as openings 19. Each such opening 19 has a circular perimeter edge 38 surrounding a cavity 41 extending into a surface such as the strap 12 or in some cases a buckle member 16. Either of the projections 18 or recesses formed as openings 19, which together form a coupling can be positioned at the first end 13 of the strap 12 with the other of the projections 18 or recesses, such as openings 19 or curved surface 29 not at the first end 13, being positioned at the distal end 15 of the strap 12.

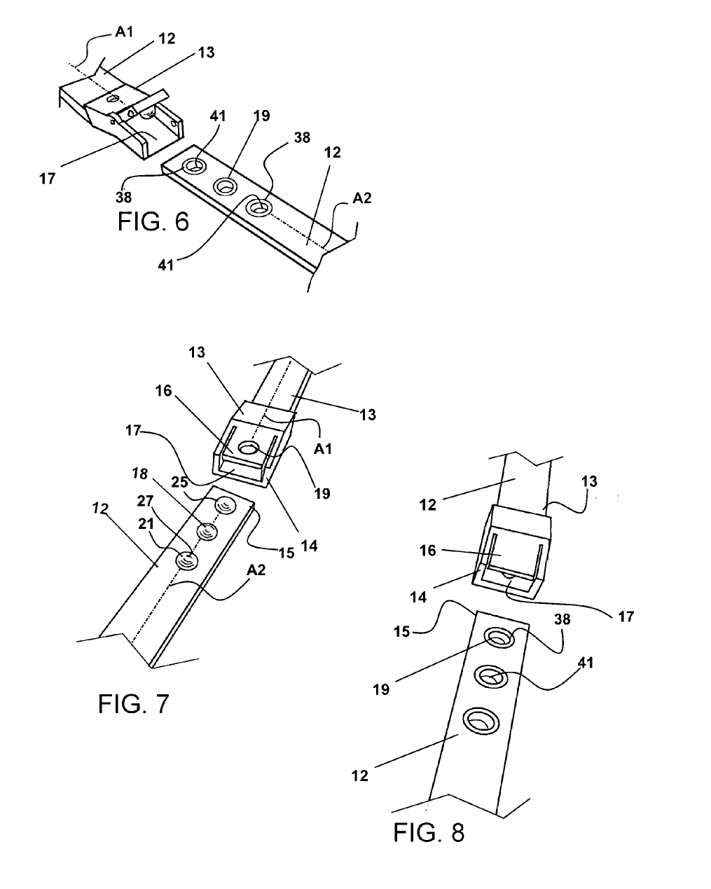

Each projection 18 has a curved or preferably as shown, a hemispherically curved surface 21 which rises in a curved surface to a peak 27 above the surrounding surface of the strap 12 from a perimeter edge 25 of the projection 18 (FIG. 3). The peak 27 is situated above the perimeter edge 25 of the projection 18 as well as elevated above the strap 12 surface on which the projection 18 it is engaged. This hemispherically curved surface 19 forms a ramp running from the circular perimeter edge 25 to the peak 27 centered therein, at all angles around the perimeter edge 25. This omnidirectional ramp so formed is preferred because if the collar device 10 twists in its engagement to the animal, and the force separating the two ends is at misaligned angles of axis A1 and axis A2 as in FIG. 7, the ramp will form in any direction of the force.

The ramp running on the hemispherically curved surface 21 from the perimeter edge 25 of the projections 18 to the peak 27, when engaged within a recess shown as an opening 19, communicates a vertical force to the perimeter edge 38 of the opening 18 forming a recess, along the formed ramp, which as shown will lift and disengage the projection 18 from the opening 19. Such occurs when force is communicated to the engaged projection 18 and the recess formed as an opening 19, when the distal end 15 of the strap 12 and the first end 13 of the strap 12 are pulled in opposite directions by such a force. Such a force is communicated whenever the collar device 10 with first end 13 engaged with the distal end 15 is caught on an obstacle with the animal trying to break free, for example when the collar is caught on a branch or object and the animal is hanging from the collar.

The force imparted to the collar device 10, when coupled, such as shown in FIG. 2, will pull the first end 13 in a direction away from the distal end 15 and vice versa, and will translate the distal end 15 slightly causing the ramp formed by the hemispherically curved surface 21 of the projection 18, to move and impart a lifting to the perimeter of the opening 18 providing the recess, to move the opening 19 upward toward the peak 27 of the projection 18 and release the engagement with the projection 18.

Also, as noted, when the projections 18 are placed sequentially on one end of the strap 12, to engage a recess such as an opening 19 or a curved surface 29 (FIG. 3), on the other end, to form a force-disengageable coupling, the angle and rise of the curved surface 21 from its perimeter 25 to the peak 27, can be adjusted on each sequentially placed projection 18, to increase or decrease the amount of force required to disengage the opening 19 from the projection 18. A steeper incline of the curved surface 21 to the peak 27 increases the force required to slide the perimeter edge 38 of the opening 19 toward the peak 27 for disconnection.

For example, for a heavier animal with a larger neck, the distance from the perimeter edge 25 of the projections 18 to the peak 27, can be decreased sequentially as each projection 18 in sequence gets closer to the distal end 15 or first end 12 depending on where they are mounted. Each decrease in distance from perimeter 25 to peak 27, increases the angle of the curved surface 21 and increases the amount of force required to disengage the coupling between the projection 18 and the opening 19. Thus, the larger the formed collar as in FIG. 2, the more force it will require to automatically disengage the coupling. While a simple curved surface 21 which is not hemispheric will work for the projections 18, it was found during experimentation, that when force is imparted to the first end 13 of the strap 12 and the distal end 15 to pull them away from each other, rather than maintaining alignment of the axis A1 of the first end of the strap with the axis A2 at the distal end, frequently the axis at the two ends move out of alignment. In such cases the axis A2 of the strap at the distal end 15, may be pulling in an angled direction which is misaligned with the axis A2 of the strap 12 running through the first end 13 of the strap 12, such as shown in FIG. 7. A simple curved surface running from one side of the projection 18 to the other but not all around the perimeter 25 did not work as well as the hemispherically curved surface 21 shown and preferred herein. This was because no matter the angle of the axis A1 of the first end 13 of the strap 12 formed in a collar, to the axis A2 at the distal end of the strap 12 formed to a collar, the hemispherically curved surface 21 self-aligned to the force to always form a ramp accommodating this misalignment, to lift the end of the strap 12 having the opening 19 connected thereto, off of the projection 18. As such, the hemispherically curved surface 21 on the projections 18 forming a ramp which angles at any direction around the circle of the perimeter edge 25 to the peak 27, is preferred, to accommodate a misaligned force pulling the first end 13 in a direction away from the distal end 13, and to still break the coupling.

Additionally, the hemispherically curved surface 21 of the projections 18 may also engage with a recess which is provided by an angled surface 29 depending into said flexible buckle member 16, instead of a recess formed as an opening 19 as shown in FIGS. 6-8, to hold the first end 13 of the strap 12 engaged with the distal end 15. As shown in FIG. 3, the hemispherically curved surface 21 of the projection 18 engaged to the distal end 15 of the strap 12, contacts and depends into the recess which is shown formed as an angled surface 29 of the surface of the buckle member 16 facing the open end 17, but could also be an opening 19 on the flexible member 31. Either would form the coupling when engaged with a projection 18 adapted to break away under force. Under such force imparted to the collar, as noted above, the distal end 15 and the first end 13 are pulled away from each other with either a respective aligned or misaligned axis. In either case, the formed coupling will disengage when the ramp formed by the hemispherically curved surface 21 of the projection 18, in a contact with the recess formed by an angled surface 29 or with the perimeter 38 of an opening 19 forming the recess, overcomes the bias of the flexible member 31, and lifts it to disengage the projection 18 from the angled surface 29 or the recess formed by the opening 19.

As such, all modes of the preferred coupling have projections 18 with a hemispherically curved surface 21, which engage a recess such as an opening 19 within a perimeter 38, or a curved surface 29 formed as a mating connector, which will lift off engagement to the projection 18, when force pulling the first end 13 of the strap 12 away from the distal end 15, causes the end of the strap 12 with the projections 18 thereon, to translate slightly which causes the ramp formed by the hemispheric curved surface 21, to impart force to lift off the recess, which may be a recess formed as an opening 19 in either end, or a recess formed as a curved surface 29, depending into a facing surface of the biased member 31. The formed ramp by the hemispherically curved surface 21, under force thus in all modes will disengage the coupling connecting the two ends of the strap 12 by contact with the recess, such as with the perimeter 38 of the opening 19 or the curved surface 29, and thereby force it toward and off the peak 27 end of the projection 18, and thereby disengage it from the projection 18.

Further, as noted, the projections 18 are employable to removably engage either an opening 19 formed on a buckle member 16 at the open end 17 of the buckle 14 where the projections 18 are on the distal end 15 of the strap 12 such as in FIG. 7, or openings 19 engaged with the distal end 15 of the strap 12 which engage a projection 18 on the buckle member 16 in the open end 17 of the buckle 14 as in FIG. 6 or 8, or, projections 18 extending from engagements on the distal end 15 of the strap 12, which engage under a curved surface 29 of a flexible buckle member 16 as in FIG. 3, or variations thereof as would occur to those skilled in the art.

In all such modes of the device 10 where a hemispherically curved surface 21 of the projection 18, forms a ramp to impart force to a mating connector or recess, the formed coupling holding the distal end 15 of the strap 12 to the first end 13, will disengage under a determined force. This would be a force which is generated by the sliding ramp formed by the hemispherically curved surface 21 on the projection 18, which is sufficient to lift the mating recess off of engagement with the projection 18. The steepness of the curve 21 from the perimeter edge 25 to the peak 27 and the elevation of the peak 27 above the planar surface of the strap 12 to which the projection 18 engages and extends from, are employable to adjust the force so developed.

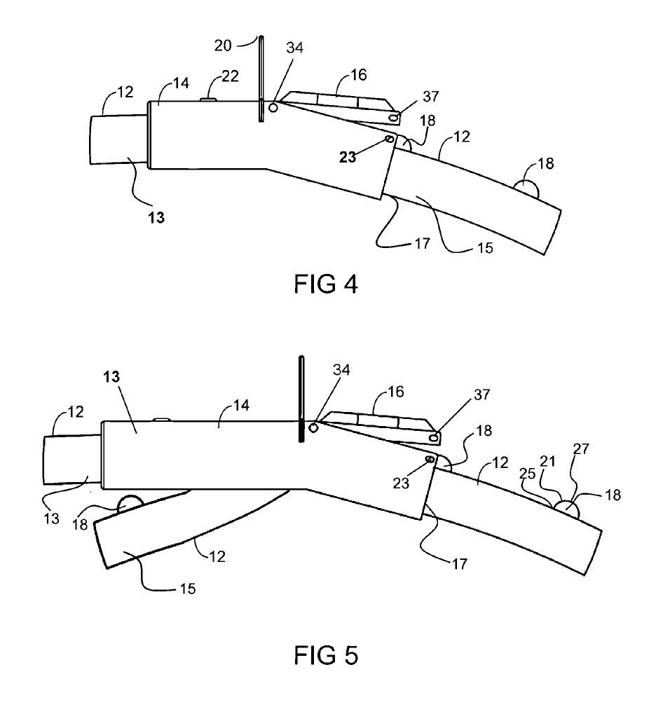

As seen in FIGS. 4-5, the buckle member 16 may be pivotally engaged adjacent a first end of the buckle 14, such as with a pin 34 extending outwards from the proximal end of both sides of the buckle member 16. This mode of the force-disengageable coupling between the two ends of the strap 12, engages a matching recess such as an opening 19 such as in FIG. 7 or a curved surface 29 such as in FIG. 3, upon the depicted buckle member 16, which is rotationally or otherwise engaged with the buckle 14. In the mode of FIGS. 4-5, the buckle member 16 has a second or an open position rotated away from the buckle 14 at the open end 17, which disengages the coupling, and a first or closed or engaged position adjacent the buckle 14 at the open end 17, where the projection 18 on the distal end 15 of the strap 12 is removably engaged to the recess in the buckle member 16 such as the curved surface 29 or an opening 19 formed therein.

In this mode, with the rotationally engaged buckle member 16, upon compressing of the buckle member 16 to rotate the distal end toward the buckle 14, the snap projections 37 on the buckle member 16 splay the side walls of the buckle 14 and engage with corresponding apertures 23 in the buckle 14 to removably engage the buckle member 16 to a closed position and prevent rotation of the second end of the buckle member 16 away from the buckle 14 at the open end 17, unless forced open by the noted vertical force generated by the ramp formed by the curved surface 21 of a projection 18.

As noted, the collar configuration of the device 10 shown in FIG. 3 is removably secured with the break away coupling formed by inserting the distal end of the strap 12 into the open end 17 of the buckle 14, which rotates or bends a flexible buckle member 16 and allows insertion of the distal end 15 of the strap 12 into the open end 17. During insertion the curved surface 29 formed into the buckle member 16, will engage and hold the projection 18 within the open end 17 of the buckle 14 until forced out by the action of the ramp, in the manner noted above. Such constrains the distal end 15 of the strap 12 by the cooperative engagement of the projection 18 and forms a flexible collar configuration as shown in FIG. 2, which can be engaged around the neck of an animal such as a cat.

The geometries of the face of the curved surface 19 of the buckle member 16, or extending on the curved hemispheric surface 21 within the perimeter edge 25 of the openings 19, if positioned in the strap 12 as in FIG. 6, preferably engage and form the curved ramp 21 structure. This ramp structure formed by the curved surface 21 of a projection 18, is configured to accommodate a maximum force generated by either the weight of an animal hanging from the strap 12 formed to a collar as in FIG. 2, or the force generated by the animal trying to escape an entanglement of the collar with an object. This force, no matter how developed, is communicated to the strap 12, when formed to a loop or collar, in a manner where the distal end 15 of the strap 12, engaged with the first end 13, is being pulled laterally in a straight or angled direction away from the open end 17 of the buckle 14.

Release of the distal end of the strap 12 from the buckle 14 is automatic, thereby releasing the animal from the formed collar, when the applied tensile force pulling the distal end 15 away from the first end 13 of the strap 12, communicates a vertical force from the curved surface 21 of the projections 18 forming the ramp, which is sufficient to lift the buckle member 16, be it rotationally engaged as in FIGS. 4-6, or flexibly connected to bend, as in FIGS. 3 and 7-8. This lifting force thereby disengages the buckle member 16 engaged to the first end 13 of the strap, from the distal end 15 of the strap 12.

The height and the curved surface 21 at the peak 27 of the projection 18, and the length and angle of the curved surface 21 from the perimeter 25 to the peak 27 defining a ramp length, ramp and the force of the engagement between the protrusions with the body of the buckle 12, or the force required to flex the flexible buckle member 16 can all be adjusted, to thereby adjust the amount of lateral force required to cause the formed ramp to lift and move the buckle member 16 of the buckle 14 to the open position to disengage the distal end 15 from the first end 12 and thereby disengage the collar from the animal.

As noted a hook 20, which allows for attachment of leashes and identification tags to the animal can be included with the device 10. Also, the device 10 can be configured where the distal end 15 of the strap 12 terminates at and does not extend through or beyond insertion into the buckle 14, such that only one projection 18 is captured by the buckle member 16 in the closed configuration of the device 10 shown in FIG. 3, or it can be configured to allow the distal end 15 of the strap 12 to slide through the open end 17 and the formed buckle 14 such as in FIG. 5. In the mode of the device 10 of FIG. 5, no trimming of the strap 12 is necessary, as the strap 12 will pass through the buckle 14 and underneath the proximal end of the strap 12.

FIG. 6 depicts the mode of the device 10 where the openings 19 have beveled or ramped perimeter edges 38 surrounding the cavity depending into the strap 12 and are formed sequentially in the strap 12 and engage a curved surface 21 of a projection 18 extending from the bottom of the pivoting buckle member 16.

In another discussed mode of the device 10, FIG. 7, shows the device with sequentially positioned projections 18 at the distal end 15 of the strap 12. As shown the projections 18 engage an opening 19 which is positioned in a flexible buckle member 16, rather than hinged buckle member 16 of the other modes of the device. A similar configuration of a flexing buckle member 16 is shown in FIG. 8, which also shows the discussed mode having sequential recesses 19 formed in the distal end of the strap 12 adapted to engaged a curved projection 18 extending from the flexible buckle member as in FIG. 7.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A break away collar adapted for engagement with an animal, comprising:
a strap having a first end opposite a distal end;
at least one projection extending from one of said first end or said distal end;
each said projection having a curved surface extending from a perimeter edge of said projection to a peak centered within and elevated above, said perimeter edge;
at least one recess positioned at the other of said first end or said distal end;
said projection engageable in a coupling with said recess by positioning said curved surface of said projection in a communication projecting into said recess positioning said curved surface in contact with a surface of said recess, said coupling holding said first end adjacent to and in a connection with said distal end of said strap, to form it to a collar configuration;
said curved surface of said projection forming a ramp; and
force imparted to said strap while in said collar configuration in a direction pulling said first end away from said distal end, imparting a sliding of said recess upon said ramp in a direction toward said peak of said projection to a disengagement of said coupling, whereby said strap in said collar configuration in an engagement with an animal, is released from such engagement upon communication of said force to said strap.

2. The break away collar of claim 1, additionally comprising:
said curved surface of said projection being a hemispherically curved surface extending from said perimeter edge positioned on a surface of said strap to said peak which is centered within said perimeter edge; and
said hemispherically curved surface forming said ramp imparting said sliding of said recess thereon at any angle running between said perimeter edge of said projection and said peak, during said pulling of said first end away from said distal end when an axis of said strap at said first end, is either aligned or mis aligned with an axis of said strap at said second end.

3. The break away collar of claim 1 wherein said recess is a circular opening having a perimeter edge surrounding a cavity and;
said sliding of said opening being a sliding of said perimeter edge upon said curved surface.

4. The break away collar of claim 2 wherein said recess is a circular opening having a perimeter edge surrounding a cavity; and
said sliding of said opening being a sliding of said perimeter edge upon said curved surface.

5. The break away collar of claim 3 wherein said perimeter edge of said recess is beveled.

6. The break away collar of claim 4 wherein said perimeter edge of said recess is beveled.

7. The break away collar of claim 3, additionally comprising:
a buckle having a first end engaged with said first end of said strap, said buckle extending to a second end opposite said first end;
said buckle having a buckle member extending from a first end engaged adjacent said first end of said buckle, to a distal end;
an open end of said buckle formed between said distal end of said buckle member and said second end of said buckle;
said opening positioned on a surface of said buckle member which faces said open end in-between said first end of said buckle member and said distal end of said buckle member;
a plurality of said projections sequentially positioned at said distal end of said strap; and
said second end of said buckle member movable by contact of said ramp with said perimeter of said opening between a first position wherein said projection is engaged within said opening thereby forming said coupling, and a second position wherein said contact of said ramp with said perimeter of said opening disengages said coupling.

8. The break away collar of claim 4, additionally comprising:
a buckle having a first end engaged with said first end of said strap, said buckle extending to a second end opposite said first end;
said buckle having a buckle member extending from a first end engaged adjacent said first end of said buckle, to a distal end;
an open end of said buckle formed between said distal end of said buckle member and said second end of said buckle;
said opening positioned on a surface of said buckle member which faces said open end in-between said first end of said buckle member and said distal end of said buckle member;
a plurality of said projections sequentially positioned at said distal end of said strap; and
said second end of said buckle member movable by contact of said ramp with said perimeter of said opening, between a first position wherein said projection is engaged within said opening thereby forming said coupling, and a second position wherein said contact of said ramp with said perimeter of said opening disengages said coupling.

9. The break away collar of claim 3, additionally comprising:
a buckle having a first end engaged with said first end of said strap, said buckle extending to a second end opposite said first end;
said buckle having a buckle member extending from a first end engaged adjacent said first end of said buckle, to a distal end;
said projection extending from said buckle member within an open end formed between said distal end of said buckle member and said second end of said buckle, said projection extending from a first end engaged therewith in a direction toward said second end of said buckle to said peak;
said at least one recess being a plurality of said openings sequentially positioned at said distal end of said strap; and
said second end of said buckle member movable by a contact with said ramp with said perimeter of said opening, between a first position wherein said projection is engaged within a said opening thereby forming said coupling, and a second position disengaging said coupling.

10. The break away collar of claim 4, additionally comprising:
a buckle having a first end engaged with said first end of said strap, said buckle extending to a second end opposite said first end;
said buckle having a buckle member extending from a first end engaged adjacent said first end of said buckle, to a distal end;
said projection extending from said buckle member within an open end formed between said distal end of said buckle member and said second end of said buckle, said projection extending from a first end engaged therewith in a direction toward said second end of said buckle to said peak;
a plurality of said openings sequentially positioned at said distal end of said strap; and
said second end of said buckle member movable by contact of said ramp with said perimeter of said opening, between a first position wherein said projection is engaged within a said opening thereby forming said coupling, and a second position disengaging said coupling.
